(19) United States
(12) Patent Application Publication
(10) Pub. No.: US 2002/0188233 A1
(43) Pub. Date: Dec. 12, 2002

(54) Stimulation device

(76) Inventor: Judson L. Denyes, Thonotosassa, FL (US)

Correspondence Address: Richard C. Litman, LITMAN LAW OFFICES, LTD., P.O. Box 15035, Arlington, VA, 22215, US

(21) Appl. No.: 09/876,109

(22) Filed: Jun. 8, 2001

(51) Int. Cl. A61H 1/00

(52) U.S. Cl. 601/46

(57) ABSTRACT

The instant invention is drawn to a vibrating stimulation device that allows its user a variety of alternatives. The basic unit comprises a handle which houses batteries for providing power to induce vibratory motion. The handle is provided with multiple connectors to accommodate a variety of stimulation attachments. Each attachment has a inducing motor encased therein. Attachments for the basic unit include a phallus-like shaft, a clitoral stimulater and an anal stimulater. All attachments are removable and may be replaced with attachments of different design, size and function.

### BACKGROUND OF THE INVENTION

1. Field of the Invention

The present invention generally relates to stimulating devices. More specifically, the present invention is drawn to a vibratory device for simultaneously stimulating various erogenous regions of the human anatomy.

2. Description of the Related Art

Marital or sexual aids have been used for centuries to assist people who may be dysfunctional because of physical and/or psychosexual problems. These aids have also been utilized to simply enhance sexual pleasure.

Many of the sexual aids in the prior art involve a vibrating and/or oscillating phallus. Examples of such aids are exemplified in U.S. Pat. No. 3,626,931 (Bysakh), U.S. Pat. No. 3,991,751 (O'Rourke), U.S. Pat. No. 5,470,303 (Leonard et al.), U.S. Pat. No. 5,573,499 (McAllister) and U.S. Pat. No. 5,928,170 (Garrigan). It is noted that the above cited patents do not contemplate the simultaneous stimulation of multiple areas of the body.

U.S. Pat. No. 3,504,665 (Bakunin et al.) and U.S. Pat. No. 5,725,473 (Taylor) disclose devices which stimulate more than one body area however, the devices do not provide for an array of interchangeable parts and are cumbersome and relatively difficult to use.

U.S. Pat. No. 5,609,603 (Kain) shows a device which is most effective when utilized by two females.

None of the above inventions and patents, taken either singularly or in combination, is seen to disclose a device for simultaneously stimulating multiple areas of the body as will subsequently be described and claimed in the instant invention.

### SUMMARY OF THE INVENTION

The device of the instant invention, dubbed “The ULTIMA-2000”, is a vibrating stimulater that allows its user a variety of alternatives. The basic unit comprises a handle which houses a battery(s) for inducing vibratory motion in stimulation attachments. The handle is provided with multiple connectors to accommodate a variety of stimulation attachments. Attachments for the basic unit include a phallus-like shaft, a clitoral stimulater and an anal stimulater. All attachments are provided with vibratory motors housed therein. The attachments are also removable and may be replaced with attachments of different design, size and function. In one embodiment, an attachment incorporates a vibrating egg, which egg may be injected into a user's vagina. The handle itself may be made in different designs and sizes which would allow for multiple combinations of handles and attachments that would appeal to a variety of aesthetic tastes. A handy carrying case is provided to house the device for easy and convenient portability.

Accordingly, it is a principal object of the invention to provide a device, which device can be utilized as a sexual stimulater.

It is another object of the invention to provide a device, which device can provide simultaneous stimulation to multiple areas of the human body.

It is a further object of the invention to provide a sexual stimulation device, which device incorporates a variety of removable attachments.

Still another object of the invention is to provide a sexual stimulation device and attachments therefor which are housed in a convenient, portable case.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is a plan view of a stimulation device according to the present invention.

FIG. 2 is an exploded view of second embodiment of a stimulation device according to the present invention.

FIG. 3 is a plan view of a clitoral stimulator attachment according to the present invention.

FIG. 4 is an exploded view of an egg ejector attachment in its retracted state according to the present invention.

FIG. 5 is an exploded view of an egg ejector attachment in its released state according to the present invention.

FIG. 6 is a plan view of a case for housing and transporting the stimulation device according to the present invention.

Similar reference characters denote corresponding features consistently throughout the attached drawings.

### DETAILED DESCRIPTION OF THE PREFERRED EMBODIMENTS

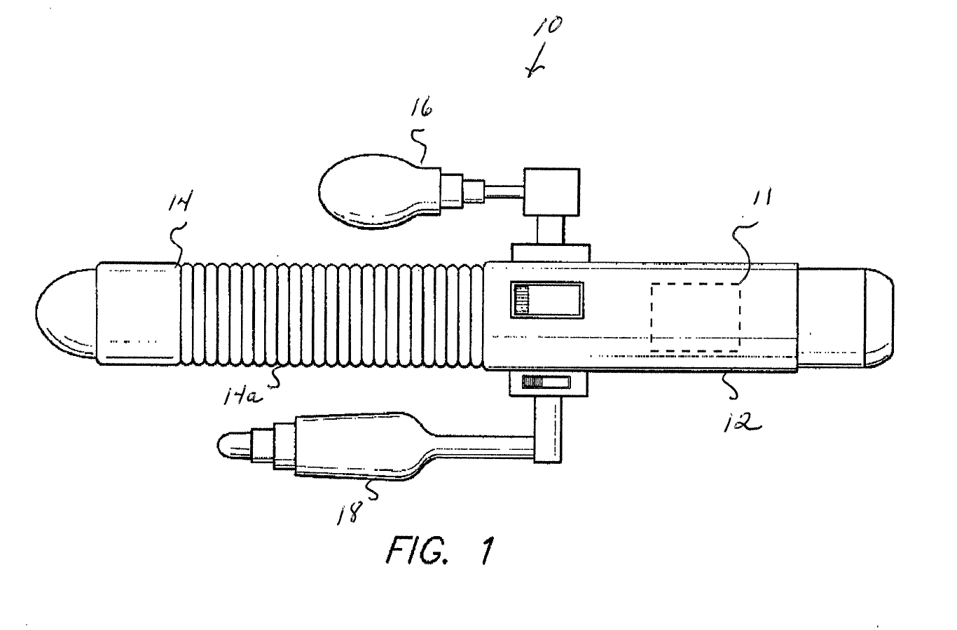

Attention is first directed to FIG. 1 which illustrates the stimulation device of the present invention generally at 10. Device 10 comprises a handle 12 which houses conventional batteries 11 (shown in phantom lines) for producing vibratory impulses in a removable shaft 14 and other removable attachments. Shaft 14 is generally of phallic configuration and may be designed with rib structure 14a or the like to enhance vibratory sensation. A vibrating, telescoping clitoral stimulater 16 and a vibrating anal stimulater 18 are also removably attached to handle 12.

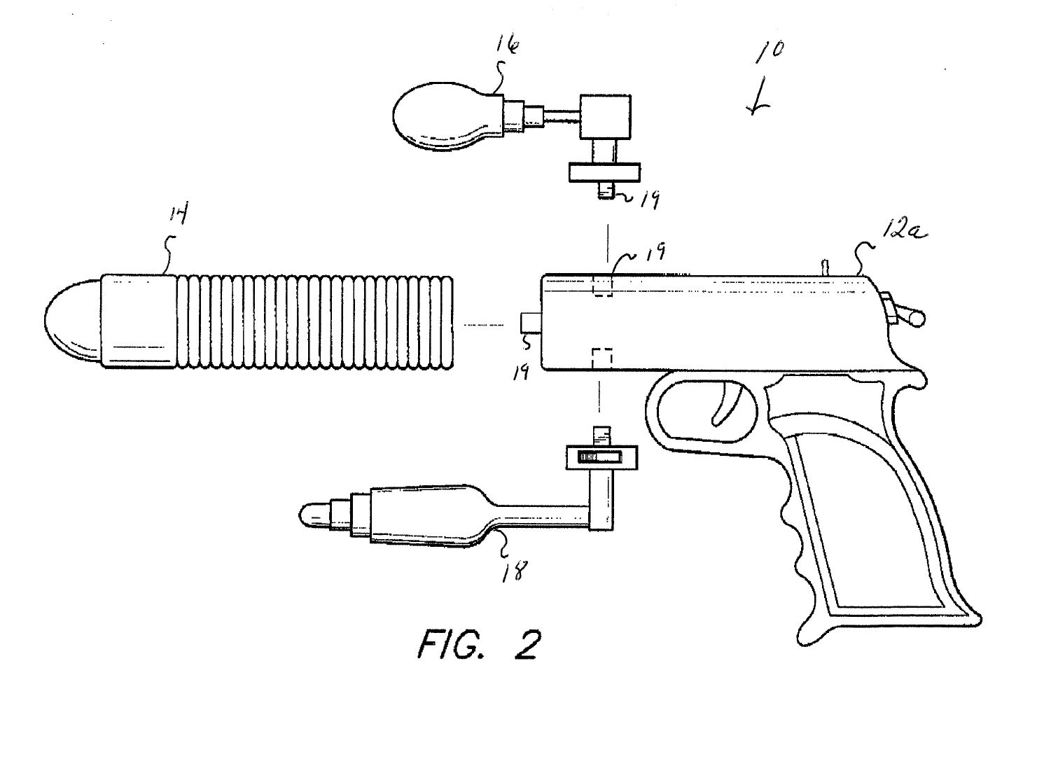

FIG. 2 shows a second embodiment of the invention wherein the handle 12a is designed to replicate a hand gun. As noted above, members 14, 16 and 18 may be readily connected and disconnected to any designed handle. The connection devices may take on the form of well known male and/or female connector clips 19.

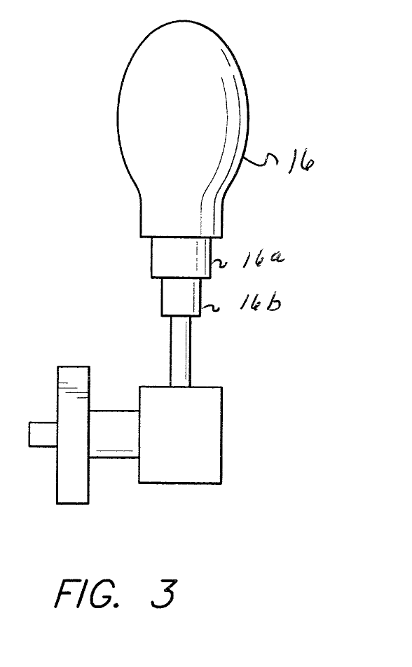

A detailed view of the clitoral stimulater 16 is illustrated in FIG. 3. Clitoral stimulater 16 comprises vertically telescoping sections 16a, 16b which allows the stimulater to be self-adjusting and remain in contact with the clitoris when used.

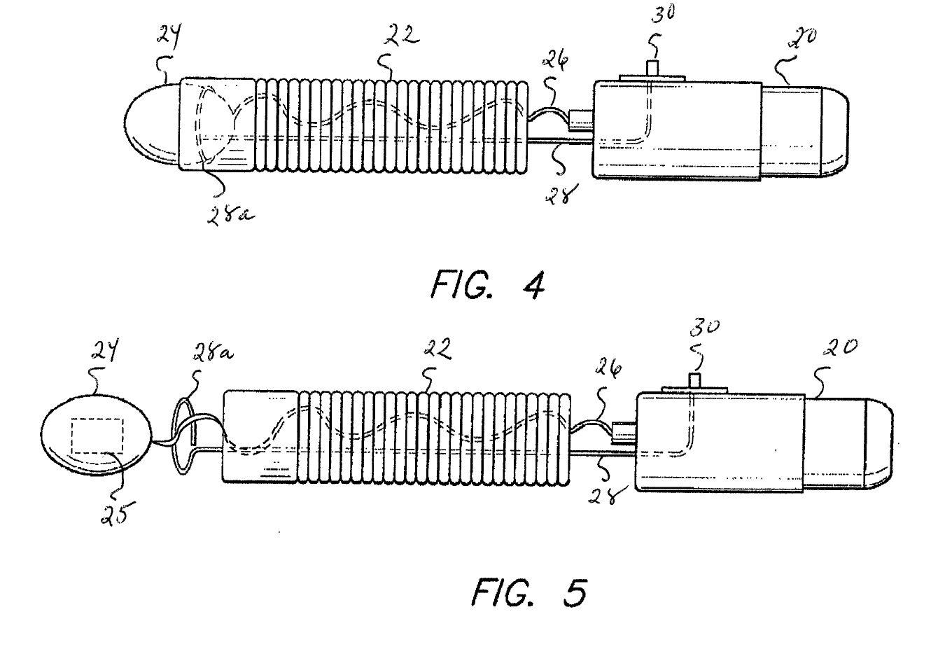

FIG. 4 shows an embodiment wherein a handle 20 and shaft 22 incorporate a vibrating egg-shaped member 24 disposed at the end of shaft 22. Vibration is induced in member 24 via wire 26, which wire is connected to a battery (not shown) housed in handle 20. An ejection rod 28 is provided with a cradle 28a at one end. Cradle 28a is of a circular configuration and is designed to nestle member 24 therein. Manipulation of control 30 will cause ejection rod 28 to push and separate member 24 from the top of shaft 22. Wire 26 remains connected to member 24 (FIG. 5). In use shaft 22 and member 24 are inserted in the vagina and caused to vibrate. Manipulation of control 30 functions to cause member 24 to be separated from shaft 22. The shaft may now be removed from the vagina leaving vibrating member 24 therein.

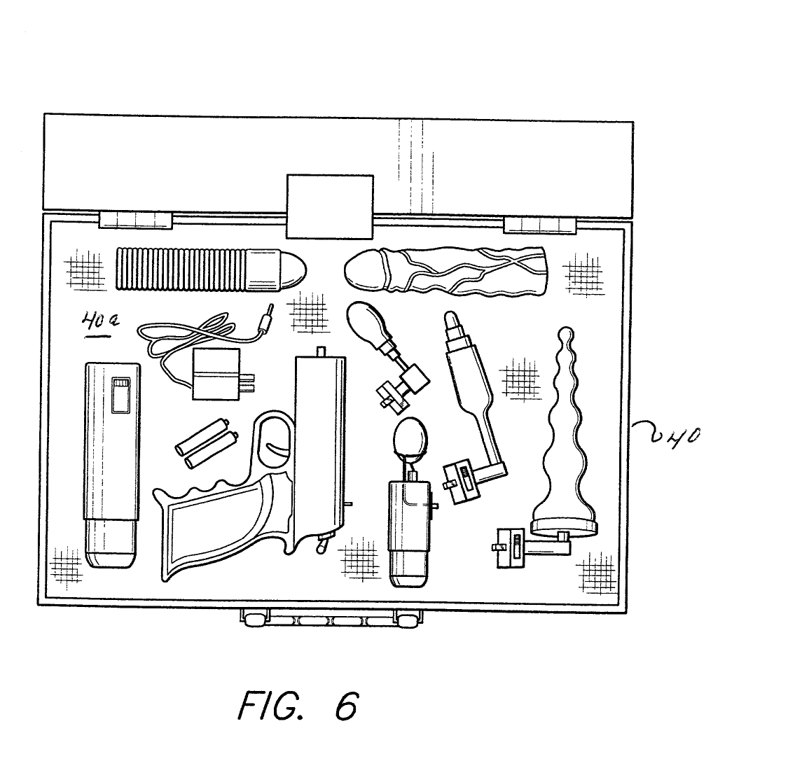

For convenience, an array of handles and attachments are neatly arranged and housed in a wall 40a of carrying case 40 (FIG. 6). This arrangement allows for portability, easy access and is a deterrent against loss and/or misplacement of individual parts.

Since all are removable or interchangeable, a user can select the combination of handles and attachments to create desired sensations. For example, if only vaginal stimulation is desired, a user would select a handle and shaft. If clitoral and/or anal stimulation is wanted, it would be a simple matter to attach the pertinent stimulation device(s) to the handle. All attachments are provided with a conventional vibration inducing motor such as shown in phantom lines at 25 (FIG. 5).

It is to be understood that the present invention is not limited to the embodiments described above, but encompasses any and all embodiments within the scope of the following claims.

I claim:

1. A stimulation device comprising:
a handle, said handle having a first end and a peripheral wall;
a plurality of connector clips, said connector clips positioned on said first end and on said peripheral wall of said handle;
a plurality of stimulation members, said members being removably attached to said handle via said connector clips; and
means for causing vibration of said stimulation members.

2. A stimulation device as recited in claim 1, wherein said means for causing vibration is a vibration inducing motor encased in said attachments.

3. A stimulation device as recited in claim 2, wherein said plurality of stimulation members include a phallic-configured shaft.

4. A stimulation device as recited in claim 3, wherein said phallic-configured shaft is attached to said handle at said first end.

5. A stimulation device as recited in claim 4, wherein said plurality of stimulation members include an anal stimulation member.

6. A stimulation device as recited in claim 5, wherein said anal stimulation member is attached to said handle on said peripheral wall.

7. A stimulation device as recited in claim 6, wherein said plurality of stimulation members include a clitoral stimulation member.

8. A stimulation device as recited in claim 7, wherein said clitoral stimulation member is attached to said handle on said peripheral wall.

9. A stimulation device as recited in claim 8, wherein said clitoral stimulation member comprises telescoping walls.

10. A stimulation device as recited in claim 9, including a portable carrying case, said case having means for neatly housing said handle and said stimulation members.

11. A stimulation device comprising:
a handle, said handle having a first end and a peripheral wall;
a plurality of connector clips, said connector clips positioned on said first end and on said peripheral wall of said handle;
a stimulation member, said member being removably attached to said handle at said first end via one of said plurality of connector clips; and
first means for causing vibration of said stimulation member.

12. A stimulation device as recited in claim 11, wherein said stimulation member comprises:
a shaft member having an open end;
an egg-shaped member disposed in said open end; and
second means for causing said egg shaped member to be ejected from said open end of said shaft member.

13. A stimulation device as recited in claim 12, wherein said second means is an ejection rod housed in said shaft member.

14. A stimulation device as recited in claim 13, wherein said ejection rod has a first end and wherein said first end is configured as a loop.

15. A stimulation device as recited in claim 14, wherein said egg-shaped member is cradled in said loop.
